(19) United States
(12) Patent Application Publication
(10) Pub. No.: US 2005/0206501 A1
(43) Pub. Date: Sep. 22, 2005

(54) Labor management system and method using a biometric sensing device

(76) Inventor: Michael Farhat, Ravenna, OH (US)

Correspondence Address: Christopher B. Jacobs;Renner, Otto, Boisselle & Sklar, LLP, 19th Floor, 1621 Euclid Ave., Cleveland, OH, 44115, US

(21) Appl. No.: 11/013,750

(22) Filed: Dec. 16, 2004

Related U.S. Application Data
(60) Provisional application No. 60/553,776, filed on Mar. 16, 2004.

(51) Int. Cl. G06F 7/04

(52) U.S. Cl. 340/5.82; 340/5.81; 235/381; 382/115

(57) ABSTRACT

A system and associated method for automating labor management functions, for example, by providing one or more self-service human resources terminals (10), each having a biometric sensing device (13), where employees can securely obtain any information relevant to them. A self-service human resources terminal (10) can be operated by an employee without the aid of anyone else, because the biometric sensing device (13) can identify the employee or verify an employee's identity accurately and securely. In a system having such a terminal (10), the employee is identified and the employee's identity is authenticated before the employee can access the employee's personal human resources data. Thus, a self-service human resources terminal (10) permits an employee to select and execute various human resource functions easily and efficiently without requiring an administrator's assistance.

This invention claims the benefit of U.S. Provisional Patent Application No. 60/553,776, filed on Dec. 31, 2003, the entire disclosure of which is hereby incorporated herein by reference.

### TECHNICAL FIELD OF THE INVENTION

The present invention relates generally to a labor management system and associated method using a biometric sensing device, and more particularly to a self-service human resource terminal having a biometric sensing device for verifying the identity of a user.

### BACKGROUND

For many industries, labor costs are typically among the largest expenditures. This creates an impetus to reduce labor costs. This impetus has led to efforts (i) to reduce time fraud by more accurately tracking when employees report to and leave from work, (ii) to reduce administrative time spent monitoring and recording employee attendance, and (iii) to more accurately associate labor cost with business units or projects where work time is spent.

Most employers prefer to have accurate accounting of employee work hours, typically by employing a system that identifies an employee at clock-in and clock-out times. Current systems use electronic identification badges or cards, punch cards, or signed time sheets, for example, to monitor employee times in and out of the workplace. Such systems allow for fraud, however, by employees passing electronic identification cards through card readers for other employees or by dishonestly completing time sheets, for example. When such fraud is a normal occurrence overall employee morale and character suffers.

Reducing administrative time and simplifying workflow also is a goal of most businesses. Human resource data, such as hours worked, hours allocated to specific projects or business units, accrued benefits such as vacation time, sick time and retirement contributions, etc., has been available in electronic form for some time. What has been lacking, however, is a system that can accurately identify the user and then allow the user access to personal human resource data as needed on a self-service basis, rather than requiring an administrator to retrieve the information for the employee. Such a system must make it very difficult for an unauthorized person to access another employee's personal data.

### SUMMARY

The present invention provides a system and associated method for automating labor management functions, for example by providing a self-service human resources terminal where employees can securely obtain any information relevant to them. A self-service human resources terminal can be operated by an employee without the aid of anyone else. In a system having such a terminal, the employee is identified and the employee's identity is authenticated before the employee can access the employee's personal human resources data. Thus, a self-service human resources terminal permits an employee to select and execute various human resource functions easily and efficiently without requiring an administrator's assistance.

During operation of the self-service human resource terminal, the employee typically is not authorized to view or to alter human resource data that is not the employee's own human resource data. For example, an employee with access to another employee's human resource data could improperly alter the attendance data or view human resource information such as schedule, benefits, reminders, bulletins, etc. Such data typically is deemed private and a system that allows such access generally is not desired.

Moreover, in most cases more than one terminal is needed to satisfy the user demand. In some cases, many terminals are needed and they can be placed at different physical locations. Thus, the present invention also provides for a system that includes a network of human resources terminals. The system can include a central processor and a data storage device or memory for storing a database of human resources data, or the processing and memory functions can be distributed among a plurality of terminals.

In accordance with a first embodiment of the invention, there is provided a method of operating a self-service human resource terminal. The method includes the step of determining an employee's identity, determining an employee reported identity code associated with an employee of the human resource terminal and retrieving an employee biometric profile that corresponds to the employee reported identity code. The method moreover includes the step of comparing the employee biometric profile with saved employee biometric characteristics and generating an identity-verified control signal if the employee biometric profile matches the saved biometric characteristic within predetermined parameters. If an identity-verified control signal is generated, the employee will be given access to human resource data that the employee is authorized to access. The method can also include the step of determining what jobs the employee is assigned to work on and generating a control signal corresponding to an employee job selection. The method can also include the step of retrieving and displaying the employee's work schedule, accrued benefits, reminders, private and public bulletins, as well as other programmable human resource functions.

In accordance with a second embodiment of the present invention, there is provided a self-service human resource terminal that includes a biometric sensing device for identifying an employee without any further information, such as the employee-reported identity code in the first embodiment. The self-service human resource terminal also includes an input device, such as a touch-screen display, for receiving an employee reported identity code associated with a user of the human resource terminal and a biometric sensing device for detecting a biometric characteristic of the employee. The self-service human resource terminal also includes a central processing unit electrically coupled to both the input device and the biometric sensing device.

Additionally, the self-service human resource terminal includes a memory device electrically coupled to the processing unit. The memory device has stored therein a database of many employee biometric profiles. In addition, the memory device has stored therein a plurality of instructions which, when executed by the processing unit, cause the processing unit to (i) compare the employee biometric profile with the biometric characteristic and generate an identity-verified control signal if the employee biometric profile matches the biometric characteristic, (ii) identify the employee based on the employee reported identity code, (iii) retrieve a employee biometric profile which correspond to the employee reported identity code, (iv) compare the employee stored biometric profile to the employee biometric profile detected by the biometric scanner for the purpose of employee identification, (v) for attendance, present the employee with a list of job selections and generate a control signal that corresponds to the employee selected job, (vi) upon request, present the employee with a work schedule, (vii) upon request, present the employee with a report of accrued benefits status, and/or (viii) upon request, present the employee with current reminders, private bulletins and public bulletins.

These and other features of the invention are fully described and particularly pointed out in the claims. The following description and annexed drawings set forth in detail illustrative embodiments of the invention, these embodiments being indicative of but a few of the various ways in which the principles of the invention may be employed.

### BRIEF DESCRIPTION OF THE DRAWINGS

FIG. 1 is a representative schematic view of a self-service human resource terminal that incorporates the features of the present invention herein;

FIG. 2 is a simplified block diagram of the self-service human resource terminal of FIG. 1;

FIG. 3 is a flow chart setting forth a general procedure for using a self-service human resource terminal for attendance functions; and

FIGS. 4A and 4B is a flowchart setting forth in more detail the itemization step of the general procedure of FIG. 3.

### DETAILED DESCRIPTION

While the invention is susceptible to various modifications and alternative forms, a specific embodiment thereof has been shown by way of example in the drawings and is described herein in detail. It should be understood, however, that the invention is not limited to the particular forms disclosed, but includes all modifications, equivalents, and alternatives falling within the spirit and scope of the invention as defined by the appended claims.

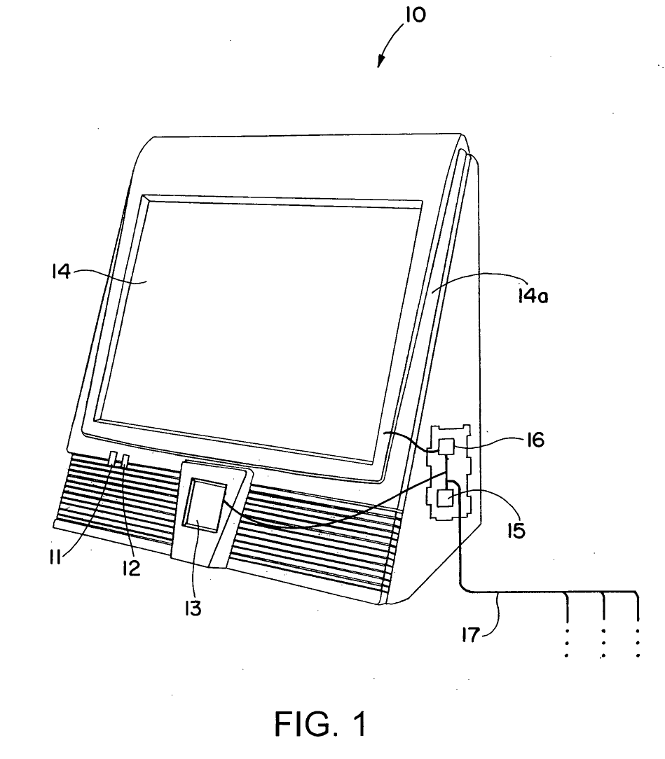

Referring to FIG. 1, there is shown an exemplary self-service human resource terminal 10 for use in any business or other employer organization, such as a non-profit or government organization for example. Although the terminal typically would be used in a fixed location, it also could be embodied in a portable unit, similar to a laptop computer. The illustrated self-service human resource terminal 10 includes a power status light 11, a memory device status light 12, a biometric sensing device 13, and a display 14, such as a touch-screen display. The terminal also includes a housing 14a, within which a processing unit 15 and a memory device 16 can be mounted.

The biometric sensing device 13 is provided to detect one or more biometric characteristics associated with a user of the self-service human resource terminal 10. What is meant herein by the term “biometric” is a substantially stable physical characteristic of a person that can be measured and characterized for comparison purposes. Examples of biometrics include fingerprint recognition, hand geometry or print recognition, iris recognition, face recognition, and speech or voice recognition. It should be appreciated that biometrics also can include behavioral characteristics such as the manner in which a person writes a signature. As discussed below in more detail, the biometric sensing device 13 can be used to identify a user as well as to verify the identity of a user.

In order to properly identify the user of the self-service human resource terminal 10, such as an employee, an employer can maintain an employee database that contains a unique alphanumeric identity code and a unique biometric profile. A reference to an employee herein is not limited to employees of one employer but generally applies to any other user of the system. In such a configuration, the employee can access human resource data and functions via the self-service human resource terminal 13 only upon successful authentication of the employee's identity using the biometric sensing device 13. This can occur in two ways: first, the employee can activate the biometric sensing device, such as by pressing a signal button via a touch-screen display 14, then by providing his or her biometric characteristic to the biometric sensing device 13 for identification. Alternatively, the employee can enter an identity code, via a touch-screen display monitor 14, e.g., which activates the biometric sensing device, then by providing his or her biometric characteristic to the biometric sensing device 13 for identification. If authentication is positive (i.e., the employee's purported identity is verified), then all the permissible self-service human resource terminal 10 functions become available to the employee.

Employers generally want to prevent a given employee from utilizing the employee reported identity code associated with a different employee to commit improprieties such as signing into work or out of work or to gain access to another employee's human resource data or information. The biometric sensing device 13 is provided to minimize or prevent such improprieties. In particular, a database can be maintained that includes a user biometric profile for each employee. Such a biometric profile includes a recognition profile associated with a particular biometric characteristic of the employee. For example, if the biometric sensing device 13 of a given self-service human resource terminal 10 is embodied as a fingerprint recognition device, the user biometric profile associated with a given employee includes a fingerprint profile. Hence when an employee attempts to access the self-service human resource terminal 10, the employee's identity can be ascertained in the manner described above and the biometric sensing device 13, in this case a fingerprint recognition device, can be used to determine or verify the identity of the employee. More specifically, the biometric sensing device 13 can be used to confirm that the person attempting to access the self-service human resource terminal 10 is actually the same person to which the user-reported identity code is assigned, thereby preventing improper access by the wrong person.

The touch-screen display monitor 14 displays instructions to guide the user through the execution of human resource functions, such as clocking in and clocking out. For example, an instruction can be displayed on the display 14 that instructs the employee to enter the employee identity code via a number pad, which can be displayed on a touch-screen display. Touch-screen displays can generate signals when certain areas of the screen are touched by a user, allowing the display to be used as both an output device and an input device.

The power status light device 11 is provided to help both the employee and a system administrator determine whether the self-service human resource terminal 10 power source is connected and active. The memory unit status light device 12 is provided to help the system administrator determine whether the self-service human resource terminal 10 memory device 16 is functioning properly.

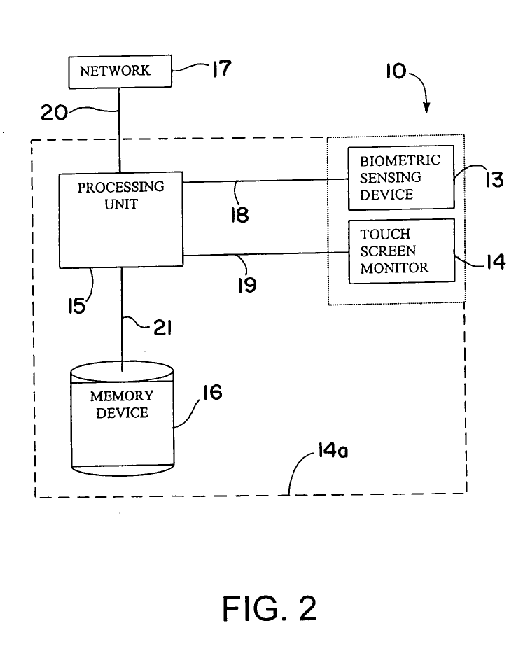

Referring to FIG. 2, there is shown a simplified block diagram of a system provided by the present invention, with one or more self-service human resource terminals 10. The processing unit 15 is electrically coupled to the biometric sensing device 13 and the touch screen display monitor 14. The processing unit 15 also is electrically coupled to a network 17 and a memory device 16.

The processing unit 15 communicates with the biometric sensing device 13 via a communication line 18. As discussed above, the biometric sensing device 13 is provided to detect a biometric characteristic associated with an employee in order to confirm the identity of the employee. Hence, the processing unit 15 monitors output signals on the communication line 18 in order to determine when the biometric sensing device 13 has captured or otherwise detected a biometric characteristic of a user. Moreover, the captured biometric characteristic can be compared to all stored or saved biometric profiles for identification of an employee, or can be compared to a single stored biometric profile associated with the employee, as identified by the identity code provided by the employee.

The biometric sensing device can be embodied as a fingerprint recognition device for detecting a fingerprint pattern associated with the user's fingerprint. Such a system typically includes an optical system having a light sensor (not shown) that captures a light pattern reflected from the user's finger. Thereafter, the light pattern can be compared to a stored fingerprint recognition profile associated with the user in order to verify the identity of the user. Any known fingerprint recognition device can be used in the biometric sensing device 13 of the present invention. One such fingerprint recognition device that is suitable for use in the biometric sensing device 13 of the present invention is the fingerprint recognition apparatus disclosed in U.S. Pat. No. 5,067,162, which issued on Nov. 19, 1991.

Alternatively or additionally, the biometric sensing device can include a facial recognition device for detecting a facial pattern associated with the user's facial characteristics. The system then generally will include a video system having a video camera (not shown) to capture an image of the user during use of the self-service human resource terminal 10. The image can be digitized or processed for comparison to a stored face recognition profile associated with the user. Any known facial recognition device can be used in the biometric sensing device 13 of the present invention. One such facial recognition device that is suitable for use in the biometric sensing device 13 in accordance with the present invention is a computer-based system operating software sold under the trademark “Facelt” which is commercially available from Visionics Corporation of Jersey City, N.J., U.S.

The biometric sensing device 13 also can include an iris recognition device for detecting an iris pattern associated with the user's iris prints. Such a system typically includes an optical system having a light sensor (not shown) that captures a light pattern reflected from the user's iris. Thereafter, the light pattern can be compared to a stored iris recognition profile associated with the user to verify the identity of the user. Any known iris recognition device can be used in the biometric sensing device 13 in accordance with the present invention. One such iris recognition device that is suitable for use in the biometric sensing device 13 is sold under the trademark “Sensar . . . Secure” and is commercially available from Sensar, Incorporated of Moorestown, N.J., U.S.

Moreover, the biometric sensing device 13 can include a hand recognition device for detecting a hand pattern associated with a user's hand characteristics. Such a system typically includes a video system having a video camera (not shown) that captures an image of the user's hand during use of the self-service human resource terminal 10. Thereafter the image can be digitized or otherwise processed for comparison to a stored hand recognition profile associated with the user. Any known hand recognition device can be used in the biometric sensing device 13. One such hand recognition device that is suitable for use in the biometric sensing device 13 in accordance with the present invention is the hand recognition apparatus disclosed in U.S. Pat. No. 5,483,601, which issued on Jan. 9, 1996.

Yet further, the biometric sensing device 13 can include a voice identification device for detecting a voice pattern or voice print associated with a user's voice or speech characteristics. Such a system typically includes an audio system having a microphone (not shown) that captures a sampling of the user's voice during use of the self-service human resource terminal 10. Thereafter the sampling can be formatted into an electronic file for comparison to a stored voice recognition profile associated with the user. Any known voice identification device can be used in the biometric sensing device 13 in accordance with the present invention. One such voice identification device that is suitable for use in the biometric sensing device 13 of the present invention is a computer-based system operating voiceprint software sold under the trademark “CITADEL GateKeeper” which is commercially available from iNTELiTRACK Technologies, Incorporated of Austin, Tex., U.S.

The illustrated processing unit 15 communicates with the display 14 through a data communication line 19, which represents both wired and wireless lines of communication. The processing unit 15 generates output signals on the data communication line 19 that cause the display 14 to display various instructional messages. The input signals from the display 14 are transmitted back to the processing unit 15 via the data communication line 19. It should be appreciated that the various instructional messages also can be communicated via other devices in addition to or in lieu of the display 14. For example, instructional messages can be generated with a voice generating device (not shown) or an audible tone generating device (not shown). As noted above, the display 14 can include touch screen technology, which can generate input signals when the user touches a particular area of a display screen associated with the display 14.

The processing unit 15 also can include network interface circuitry (not shown) that permits the self-service human resource terminal 10 to communicate with the network 17, such as a local area network (LAN) or a wide area network (WAN), through a wired or wireless connection 20. The processing unit 15 communicates with the network 17 during usage to obtain information such as authentication data, biometric profiles, attendance data, schedule data, benefits data, reminder data, bulletins, etc. The network interface circuitry associated with the self-service human resource terminal 10 can include an ethernet expansion card, and the wired connection 20 can include known twisted-pair communication line. Additionally or alternatively, the network interface circuitry can support a wireless communications network.

The processing unit 15 also communicates with the memory device 16 via a data communication line 21. The memory device can be resident in the housing 14a of the self-service human-resource terminal, can be remotely located, or can be distributed among remote and local devices. Also, the memory device can include any type of electronic data storage device, such as a hard drive, random-access-memory (RAM), read-only-memory (ROM), or an optical disk, for example. The memory device is provided to maintain the various programs' machine code responsible for the operation of the self-service human resource terminal 10. It should be understood that all the self-service human resource terminal 10 functionality is embodied in one or more machine code executable programs stored on the memory device 16 and executed by the processing unit 15.

The memory device 16 also maintains a biometric database. The biometric database includes a user biometric profile associated with each of the employer-registered employees. In particular, as soon as an employee is hired, certain biometric characteristics of the employee can be obtained and stored in the biometric database in a user biometric profile associated with the employee. For example, in a case where the biometric sensing device is embodied as a fingerprint recognition device, a digital image of one or more fingerprints can be taken from the employee. Thereafter the digital image can be formatted and stored in the biometric database as a fingerprint recognition profile associated with the employee. Similarly, a facial recognition profile, an iris recognition profile, a hand recognition profile or a voice recognition profile associated with each known user also can be stored in the biometric database. Generally, to minimize data storage requirements, only the profiles used by the system will be stored in the biometric database. The self-service human resource terminals associated with the employer's operations must be equipped with biometric sensing devices that can use such profiles. The profiles generally are stored in the biometric database in such a manner as to be retrieved in response to the user identifying himself or herself to gain access to the self-service human resource terminal 10 functions.

The biometric database can be maintained locally (i.e., saved within the self-service human resource terminal 10 memory device 16), regionally (i.e., within a group of locations in the same geographical region), or globally (i.e., at an employer's headquarters so as to be accessible at any of the employer locations). Hence, access to user biometric profiles can be configured to fit the requirements of a given employer.

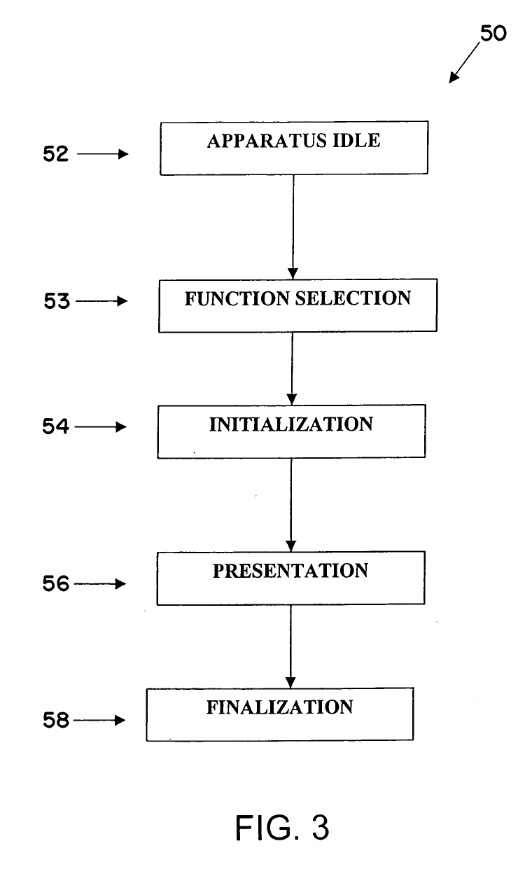

Referring now to FIGS. 1 and 3, this flowchart sets forth a general procedure 50 for executing human resource functions through the self-service human resource terminal 10. When the user arrives at the self-service human resource terminal 10, the terminal 10 typically is in an idle state (step 52). If the user chooses to execute the already-selected human resource function then the select function 53 step is complete. If the user chooses to select another human resource function, however, then he or she can do so by touching a certain area of the display 14. An initialization step 54 then is executed prior to identifying or verifying the user's identity. In particular, one or more initialization instructions are displayed at the display 14 that instructs the user (1) to place his or her registered finger on the biometric sensor 13 or otherwise address another biometric feature to a biometric sensor or (2) to identify himself or herself by entering the user identity code using the display 14 touch screen entry pad.

Upon user authentication, and at the successful completion of the initialization step 54, the routine 50 advances to a presentation step 56 where the user is presented with instructions and selection options. These instructions and selection options differ depending on the type of human resource function being executed. For example, if the user chooses to execute an attendance function, then the user will be presented with attendance information and selection options. Hence, in step 56 the user can select a job to charge attendance time to by touching a particular area of the display monitor 14. In addition, the user can override system selections for starting shift, ending shift, starting break or ending break, for example.

At the completion of the presentation step 56, the routine 50 advances to a finalization step 58 in which (1) a transaction record is created and updated to the system database. After completion of the finalization step 58, the self-service human resource terminal returns to an idle condition until a subsequent user initiates a human resource procedure.

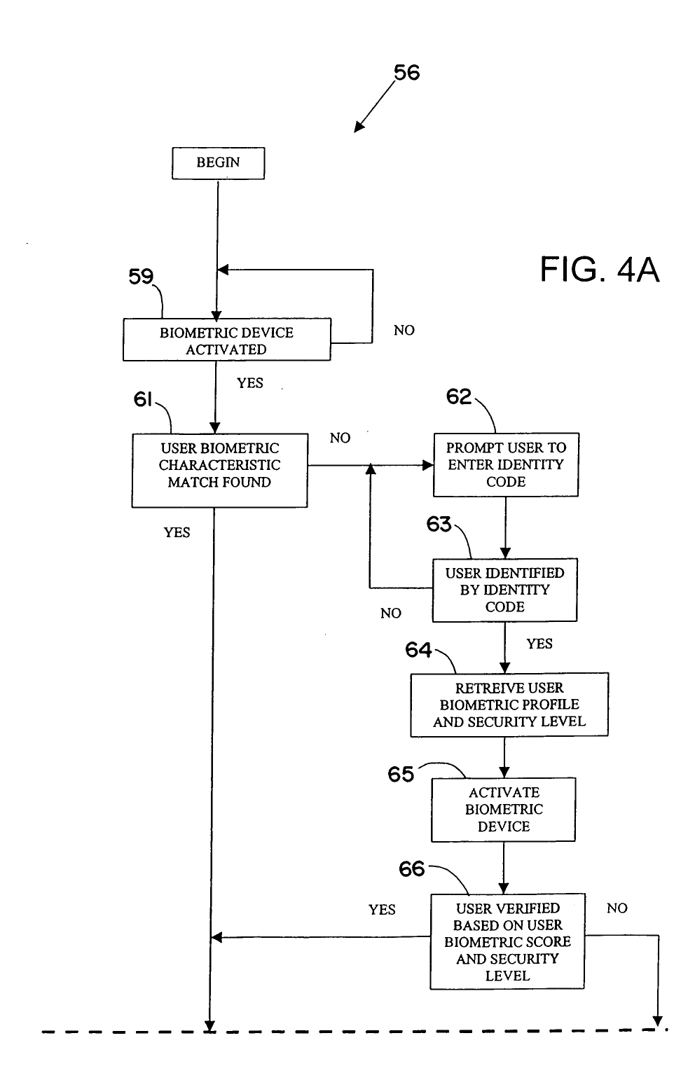

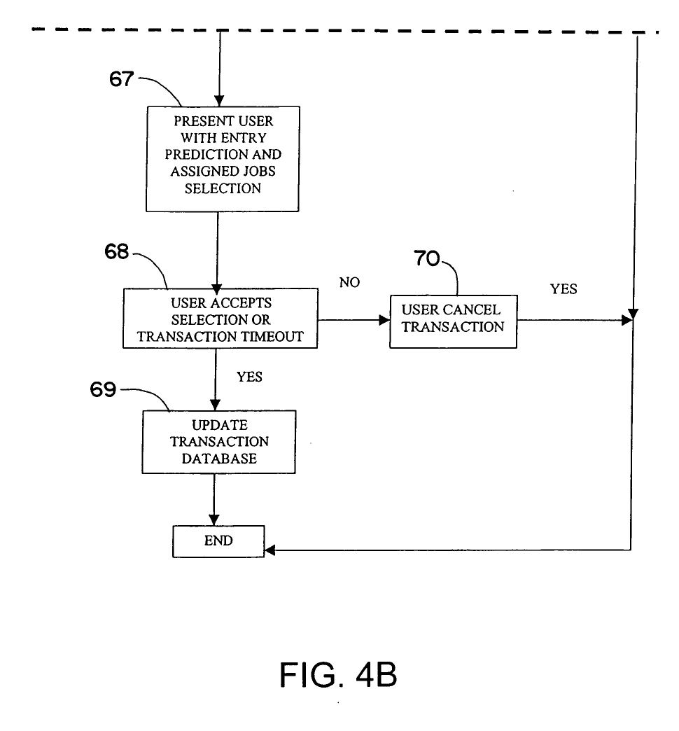

Referring now to FIGS. 4A and 4B this flowchart sets forth an exemplary presentation step 56 of FIG. 3 in greater detail. After the initialization step 54 (See FIG. 3) is completed, the routine 56 advances to step 59 in which the processing unit activates the biometric device 13 (FIG. 1). The biometric device 13 can be activated automatically or it can be activated by a user command such as by pressing one or more command buttons presented on the display 14. Once the processing unit 15 has activated the biometric device 13, the routine 56 advances to step 61.

In step 59, a message is displayed on the display 14 that instructs the user to place a registered finger on the biometric device 13 or otherwise address the biometric device so that it can obtain the desired biometric characteristic information. While the biometric device 13 is activated, it scans for the user's fingerprint. Once a fingerprint pattern is read, it is compared with a fingerprint pattern in the system fingerprint databank for a possible match. If a match is found, then the routine 56 advances to step 67 (FIG. 4B).

If a match is not found, then the routine 56 advances to step 62 where the user is instructed, via a message that appears at the display monitor 14, to enter his or her identity code. Once the identity code is entered then the routine 56 advances to step 63.

In step 63, the processing unit validates the user identity code with the user database. If a match is not found then the routine 56 returns to step 62 and the user is prompted to enter his or her identity code again. This process typically can be repeated for a predetermined number of times before the system times out and starts the process anew. On the other hand, if a match is found then the routine 56 advances to step 64.

In step 64, the processing unit 15 retrieves the user biometric profile and biometric security level. This information can be used to determine whether this particular user has certain biometric characteristics that require special handling or modified tuning for proper biometric verification. Then the processing unit advances the routine 56 to step 65.

In step 65, the processing unit activates the biometric device 13 and presents the user with a message that is displayed on the display monitor 14 that instructs the user to place a registered finger on the biometric device 13. While the biometric device 13 is activated, it scans for the user's fingerprint. Once a fingerprint is read, it is compared with one or more saved fingerprint profiles for a possible match. If a match is found, then the routine 56 advances to step 67. If a match is not found then the routine 56 returns to an idle state.

In step 67 (see FIG. 4B), the processing unit 15 presents the user with the information and selection options relevant to the human resource function selected in step 53 (see FIG. 3). For example, if the human resource function selected was an attendance function, then attendance-related information is displayed on the display 14. For instance, a job selection list can be presented from which the user can select the job he or she is working on. In addition, the user can be presented with additional options and selections to identify the current action, whether it is the start of a shift, the end of the shift, the start of a break or the end of a break. Now, at step 68, the user is expected to accept his or her selections, if any, thus advancing the routine 56 to step 69, or to cancel the current transaction at step 70 and end the routine 56. If the user is not interacting with the unit and neither accepts nor cancels the current transaction, the transaction is automatically accepted after a brief time delay, thus advancing the routine 56 to step 69.

In step 69, the processing unit 15 updates the system database with any information relevant to the current transaction. Then the routine 56 is completed and the processing unit executes the finalization routing 58 (see FIG. 3).

For practical considerations each user may have two or more fingerprints or other types of biometric characteristic information registered within the system. Consider now a system with thousands of users and hundreds of terminals. In such a system there will be hundreds of thousands of user fingerprint records and managing such records adds complexity to the system. Two specific sources of complexity and possible ways the system provided by the present invention is simplified will be described in the following paragraphs. The self-service human resource terminal preferably, but not necessarily, includes automated features that can automatically address such sources of complexity.

In a first example, consider that each terminal has a restricted list of users, and a particular self-service human resource terminal is malfunctioning and needs repair. A replacement terminal can be provided, and can be configured to operate without the need to re-register all of the users within the new terminal. This can be done automatically by assigning each self-service human resource terminal an identity for communication with a central server or other processor, including a processor distributed among the other terminals. Each terminal can be assigned local administrative functions to facilitate a new terminal assigning such an identity to itself automatically, or manually by a pre-authorized local administrator. Once an identity has been established for the terminal, it can automatically download biometric profiles for administrators or one or more of its users, and store such profiles locally for use in identifying users and administrators. By providing such functionality in each terminal, whenever a replacement terminal is needed any properly functioning terminal can be used. Simply by assigning the proper identity to a terminal, the terminal can download the necessary configuration information and be up and running in the matter of seconds.

Consider a second example, where although there may be thousand of users, as a practical matter not all of them will use every self-service human resource terminal. At the same time there are no limitations as to which users can use a particular terminal. Storing every potential user's biometric profile locally could potentially overwhelm the system and would likely be unmanageable. In such a case, during normal operation or when a replacement terminal is installed, as in the previous example, the terminal operates in the following manner. When a particular user attempts to access information via the terminal, and if the machine determines such user to be new (i.e., the user's biometric profile is not stored locally), then the terminal downloads the user's biometric profile from a central server and made available locally from that point on or for a predetermined period of time thereafter. Furthermore, if the user's biometric profile changes (for example, when a new or different fingerprint is registered), then whenever the user attempts to use the terminal, his or her biometric profile is downloaded from the central server. Such functionality can be referred to as “synchronization on demand.” Each terminal also can be set to automatically update or refresh the locally stored biometric profiles on a periodic basis.

Although the invention has been shown and described with respect to certain illustrated embodiments, equivalent alterations and modifications will occur to others skilled in the art upon reading and understanding the specification and the annexed drawings. In particular regard to the various functions performed by the above described integers (components, assemblies, devices, compositions, etc.), the terms (including a reference to a “means”) used to describe such integers are intended to correspond, unless otherwise indicated, to any integer which performs the specified function (i.e., that is functionally equivalent), even though not structurally equivalent to the disclosed structure which performs the function in the herein illustrated embodiments of the invention. In addition, while a particular feature of the invention may have been described above with respect to only one of several illustrated embodiments, such a feature may be combined with one or more other features of the other embodiment, as maybe desired and advantageous for any given or particular application.

1. A system for providing secure access to human resources data, comprising:
at least one terminal having a biometric sensor, an input device, an output device;
and a database of biometric profiles for comparison to biometric characteristics sensed by the biometric sensor for determining or verifying a user's identity.

2. A system as set forth in claim 1, wherein the biometric sensor includes at least one of a fingerprint recognition device, a hand geometry recognition device, a hand print recognition device, an iris recognition device, a face recognition device, a speech recognition device and a signature recognition device.

3. A system as set forth in claim 1, wherein the output device includes at least one of a display, a voice generating device and an audible tone generating device.

4. A system as set forth in claim 1, wherein the input device and the output device are formed by a touch screen display.

5. A system as set forth in claim 1, wherein the input device includes at least one of a microphone and a video camera.

6. A system as set forth in claim 1, further including a communication device for connecting the terminal to a network.

7. A system as set forth in claim 1, wherein the terminal includes at least one of a local memory and a local processor.

8. A system as set forth in claim 7, wherein the local processor includes network interface circuitry.

9. A system as set forth in claim 1, wherein the at least one terminal includes a plurality of terminals, and a network providing communication between the terminals.

10. A system as set forth in claim 9, further comprising at least one of a remote memory that is remote from at least one terminal and a remote processor that is remote from at least one terminal.

11. A method for providing secure access to human resources data, comprising the steps of:
sensing biometric characteristics of a user;
comparing the sensed biometric characteristics to a biometric profile stored in a database; and
identifying or verifying a user's identity based on the comparison of the biometric characteristics and the biometric profile.

12. A claim as set forth in claim 11, wherein the sensing step includes scanning a user's finger for a fingerprint pattern associated with a user's fingerprint

13. A method as set forth in claim 11, further comprising the step of activating a biometric sensor.

14. A method as set forth in claim 11, further comprising the step of communicating at least one of biometric characteristics and a biometric profile to a network.

15. A method as set forth in claim 11, further comprising the step of selecting a human resource function to access, and allowing the user to access the human resource function only after identifying or verifying a user's identity.

16. A method as set forth in claim 11, further comprising inputting a user identity code.

17. A system for providing secure access to human resources data, comprising:
means for sensing biometric characteristics of a user;
means for comparing the sensed biometric characteristics to a biometric profile stored in a database; and
means for identifying or verifying a user's identity based on the comparison of the biometric characteristics and the biometric profile.

18. A terminal for providing secure access to human resources data, comprising:
a housing;
a touch-screen display mounted in the housing to output information and to input information;
a biometric sensor connected to the housing for sensing biometric characteristics of a user;
a memory device for storing biometric profiles and human resources data; and
a processor connected to the display, the biometric sensor and the memory device for providing data to and receiving data from the display, the memory and the biometric sensor, and for comparing the sensed biometric characteristics and the stored biometric profiles to determine or verify a user's identity;
wherein the processor will not send human resources data to the display without confirmation of the user's identity based on the comparison.
